(19) United States
(12) Patent Application Publication
(10) Pub. No.: US 2026/0084172 A1
(43) Pub. Date: Mar. 26, 2026

(54) Sensor Painting Method, Shielding Assembly and Sensor

(71) Applicant: WHETRON ELECTRONICS CO., LTD., New Taipei City (TW)

(72) Inventor: YU-MIN LEE, New Taipei City (TW)

(21) Appl. No.: 18/950,226

(22) Filed: Nov. 18, 2024

(30) Foreign Application Priority Data
Sep. 26, 2024 (TW) 113136745

(51) Int. Cl. B05B 12/32; G01D 11/24

(52) U.S. Cl. CPC B05B 12/32; G01D 11/24

(57) ABSTRACT

A sensor painting method is adapted for solving the problem of the conventional sensor painting method involving tedious steps. The sensor painting method includes providing a sensor having a carrier and a sensing unit. The sensor is pre-assembled to install the sensing unit on the carrier. A portion of the sensing unit protruding beyond the carrier forms a protruding portion. A shielding assembly is provided to shield the protruding portion, such that an area of the protruding portion shielded by the shielding assembly forms a gap portion, and another area of the protruding portion outside of the shielding assembly forms a painting area. A painting layer is formed on the painting area. The painting layer and the gap portion have different colors. A shielding assembly and a sensor are also provided. The painting and dispatching efficiency of the sensor can be increased according to this disclosure.

### CROSS REFERENCE TO RELATED APPLICATION

The application claims the benefit of Taiwan Application Serial No. 113136745, filed on September 26, 2024, and the entire contents of which are incorporated herein by reference.

### BACKGROUND OF THE INVENTION

### 1. Field of the Invention

The present invention relates to a painting method and, more particularly, to a sensor painting method, a shielding assembly, and a sensor.

### 2. Description of the Related Art

With the development of technology and consideration of driving safety, it is common to mount a sensor (such as a radar sensor) on a carrier of a vehicle to avoid collision. To match with the color of the vehicle in the appearance, a related painting process must be carried out on a sensing unit of the sensor to provide the sensing unit exposed outside of the vehicle with a predetermined color.

With reference to FIG. 1 showing a conventional sensor after painting, which includes a sensor 9 having a carrier 91 and a sensing unit 92. The sensing unit 92 is painted and has a specific painting layer 92C disposed in a local area of the sensing unit 92. FIGS. 2 and 3 illustrate a conventional sensor painting method. During the conventional installation process of the sensor 9, the carrier 91 and the sensing unit 92 are stored separately. As shown in FIG. 2, when a supplier of the sensor 9 receives an instruction to present a specific color on a predetermined area 92A (as shown by the dotted portion) of the sensing unit 92 exposed outside of the vehicle, the sensing unit 92 is mounted on a jig 93. Next, as shown in FIG. 3, a painting process using an associated colorant is carried out on the sensing unit 92 mounted on the jig 93, forming a painting layer 92C on the sensing unit 92. Finally, after the painting layer 92C on the sensing unit 92 is dried, the sensing unit 92 with the painting layer 92C is installed on a corresponding carrier 91, thereby producing a sensor 9 (see FIG. 1) with a specific color. It is noted that to enable an automated painting process, the jig 93 has a lateral opening 931 to permit removal of the painted sensing unit 92 by a corresponding tool, such as a claw. However, the lateral opening 931 causes the painted colorant to extend beyond the predetermined area 92A.

As can be appreciated from the above conventional sensor painting method, the carrier 91 and the sensing unit 92 are stored separately. When a client demands the sensor supplier to provide a sensor including a sensing unit 92 with a specific color, the supplier must carry out a corresponding color painting on each sensing unit 92. After the paint is dried, the painted sensing unit 92 is installed on the carrier 91. Namely, to obtain a sensor 9 with a desired color, the conventional sensor painting method requires a process including painting, drying, and installation. Thus, supply of the sensor 9 is time-consuming.

Some of the suppliers prepare and store sensors painted with different colors. When a client designates the color, the sensing unit 92 of the designated color is rapidly installed on the carrier 91 to shorten the time for supplying the sensor 9. However, this pre-stock approach results in an increase in the inventory space and the cost for inventory management. Furthermore, when the color designated by the client is not the same as that of the inventory, the time-consuming conventional sensor painting method is still required.

Therefore, improvements to the conventional sensor painting method are necessary to address these issues.

### SUMMARY OF THE INVENTION

One objective of the present invention is to provide a sensor painting method which may increase the painting and dispatching efficiency of the sensor.

It is another objective of the present invention to provide a shielding assembly which may increase the painting efficiency.

It is a further objective of the present invention to provide a sensor which may increase the painting efficiency and which has a specific painting layer.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

As used herein, the term “disposition”, “arrangement”, “mounting”, “installation”, “assembly”, or similar terms is used to include separation of connected members without destroying the members after connection or inseparable connection of the members after connection. A person having ordinary skill in the art would be able to select according to desired demands in the material or assembly of the members to be connected.

A sensor painting method according to the present invention includes providing a sensor having a carrier and a sensing unit, with the sensor pre-assembled to install the sensing unit on the carrier, with a portion of the sensing unit protruding beyond the carrier forming a protruding portion; providing a shielding assembly to shield the protruding portion, such that an area of the protruding portion shielded by the shielding assembly forms a gap portion, and another area of the protruding portion outside of the shielding assembly forms a painting area; and forming a painting layer on the painting area, with the painting layer and the gap portion having different colors.

A sensor according to the present invention includes a sensor and a sensing unit. The carrier includes a receiving space. The sensing unit includes a body partially received in the receiving space, such that a portion of the body protruding beyond the carrier forms a protruding portion. A painting layer is disposed on the protruding portion. A gap portion is formed between the painting layer and the body. The painting layer and the gap portion have different colors.

Thus, in the sensor painting method and the sensor according to the present invention, by shielding the protruding portion with the shielding assembly, the protruding portion forms the painting layer and the gap portion, such that painting may be carried out on the whole sensor assembled with the carrier and the sensing unit, which saves the time for painting the sensing unit alone and then installing the sensing unit on the carrier after painting, thereby increasing the painting and dispatching efficiency of the sensor. Furthermore, the sensor is preassembled before painting, which saves the inventory space for the carrier and the sensing unit, thereby simplifying the inventory management.

In an example, the painting layer is formed by spraying or printing. Thus, the painting layer may be effectively produced.

A shielding assembly according to the present invention is applied in the above sensor painting method. The shielding assembly includes a shielding cover having a plurality of through-holes.

Thus, in the sensor painting method according to the present invention, by providing the shielding cover of the shielding assembly with a plurality of through-holes, the protruding portion of each of plural sensors may extend through a respective through-hole, such that plural sensors (each assembled with a carrier and a sensing unit) may be simultaneously painted in a painting process, thereby increasing the painting efficiency of the protruding portion of each sensor.

In an example, the shielding assembly further includes a plurality of annular shielding members. Each of the plurality of annular shielding members is disposed in a respective one of the plurality of through-holes. Thus, each individual annular shielding member may be used to surround the protruding portion of a respective sensor, thereby effectively avoiding the colorant from being painted on a portion outside of the painting area of the respective protruding portion.

In an example, each of the plurality of annular shielding members includes a flange protruding outward. When each of the plurality of annular shielding members is disposed in the respective one of the through-holes, each flange extends downward from the shielding cover in a radial direction and extends beyond a periphery of the respective through-hole. This may more effectively avoid the colorant from infiltrating and adhering to the portion outside of the painting area of the respective protruding portion.

In an example, the shielding cover is made of polypropylene. Therefore, the shielding cover may have expected chemical resistance and abrasion resistance.

In an example, the plurality of annular shielding members is made of silicone or silicone resin. Thus, each annular shielding member has certain plasticity, such that when the annular shielding member surrounds a respective protruding portion, the colorant is avoided from infiltrating to the portion outside of the painting area of the respective protruding portion.

In an example, the shielding assembly further includes a base having a plurality of grooves. Each of the plurality of grooves includes a bottom portion having at least two stepped planes. Therefore, by the provision of the grooves, each sensor may be stably placed in a specific position, thereby enhancing the painting stability. Furthermore, through provision of the grooves each including a bottom portion with at least two stepped planes, the same base is suitable for sensors with at least two shapes. Thus, when spraying sensors of different shapes, extra time for replacing the base with a corresponding shape is not required, thereby increasing the operating convenience and the spraying efficiency.

In an example, the sensor further includes a circuit board disposed in the receiving space. The sensing unit further includes an electrical connecting portion extending outward from the body and electrically connected to the circuit board. Thus, the circuit board may control transmission and reception of signals of the body, thereby achieving the function of the sensor.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a schematic perspective view of a sensor painted by a conventional sensor painting method.

FIG. 2 is a schematic view illustrating disposition of a sensing unit on a jig in the conventional sensor painting method.

FIG. 3 is a schematic view illustrating spray painting of the sensing unit in the conventional sensor painting method.

FIG. 4 is an exploded, perspective view of a first embodiment of a sensor according to the present invention.

FIG. 5 is a perspective view of the sensor of FIG. 4 after assembly.

FIG. 6 is a perspective view of a second embodiment of the sensor according to the present invention.

FIG. 7 is an exploded, perspective view of a first embodiment of a shielding assembly and the sensor according to the present invention.

FIG. 8 is a perspective view of the shielding assembly and the sensor of FIG. 7 after assembly.

FIG. 9 is a cross sectional view taken along section line 8-8 of FIG. 8.

FIG. 10 is an enlarged view of a circled portion of FIG. 9, illustrating a second embodiment of the shielding assembly according to the present invention.

FIG. 11 is an enlarged view of a circled portion of FIG. 9, illustrating a third embodiment of the shielding assembly according to the present invention.

FIG. 12 is a schematic perspective view of a sensor after painting.

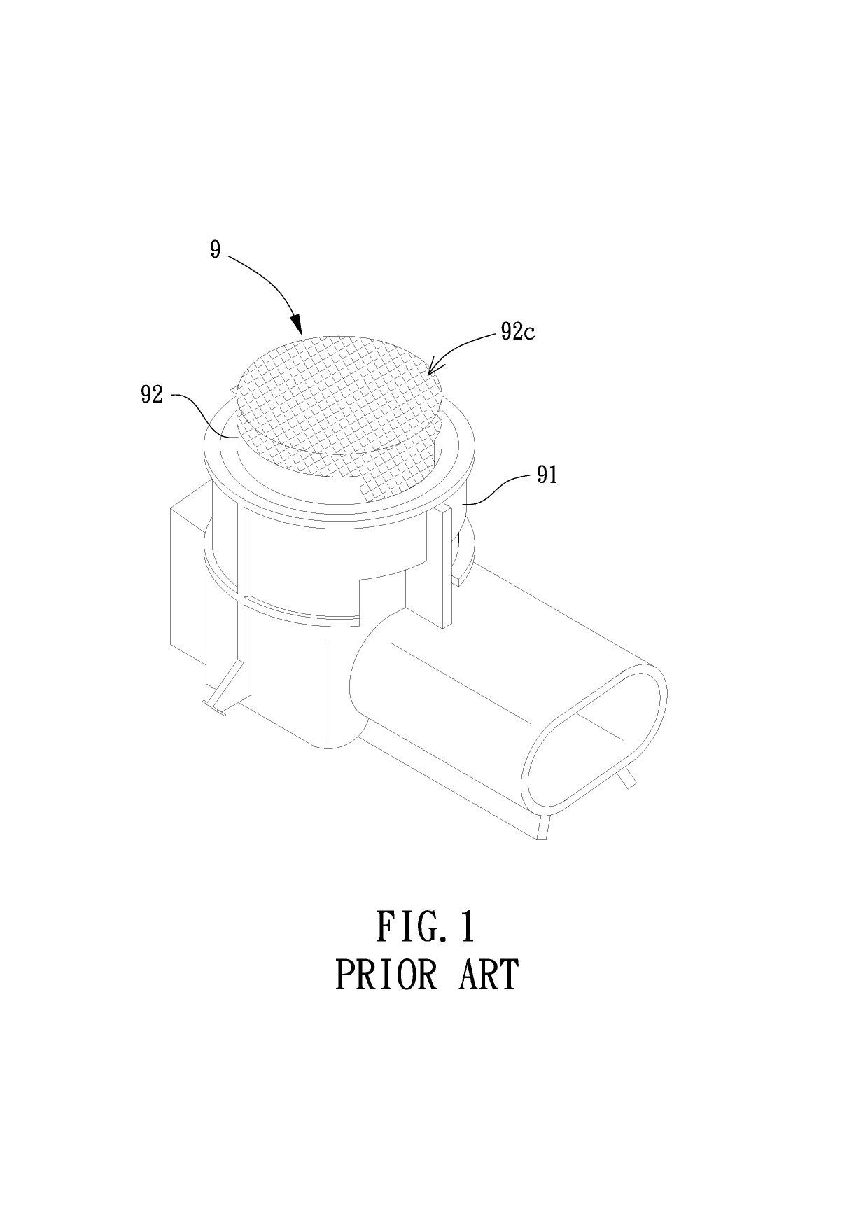

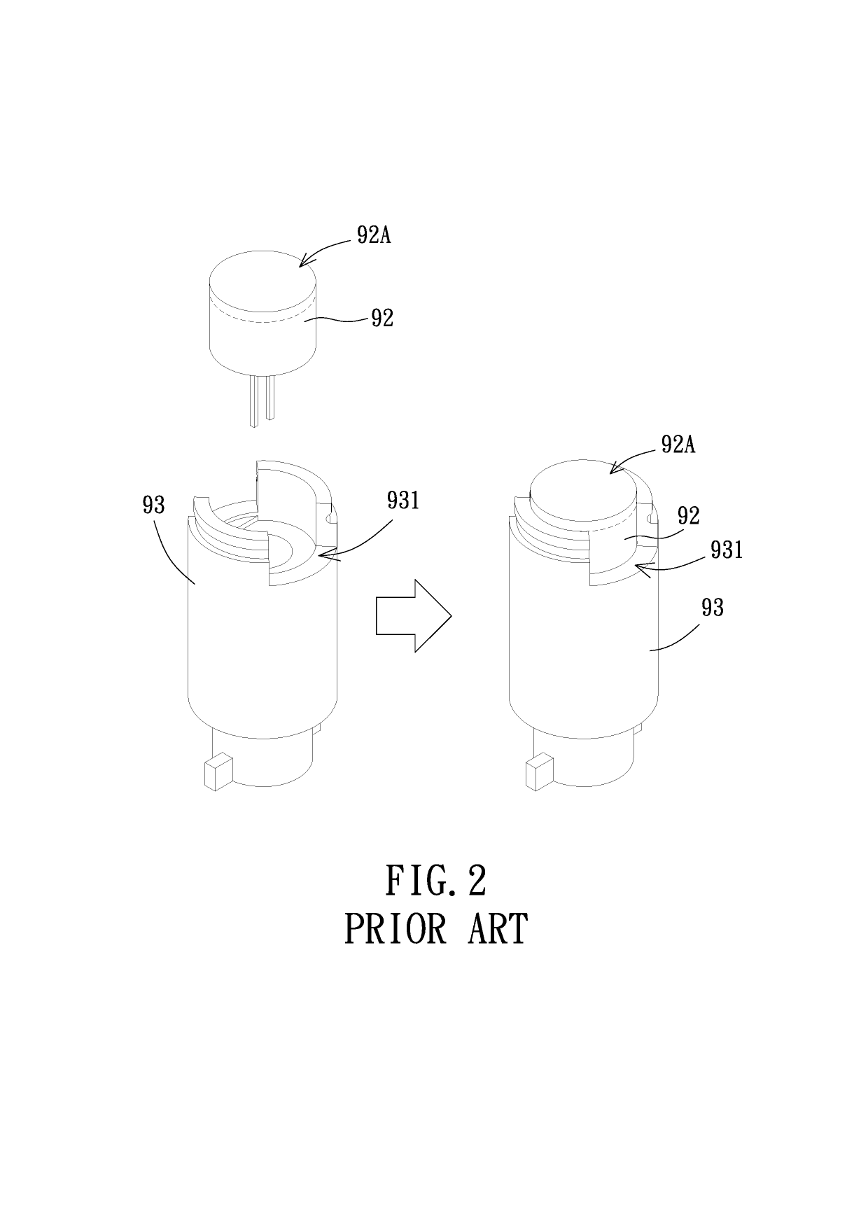

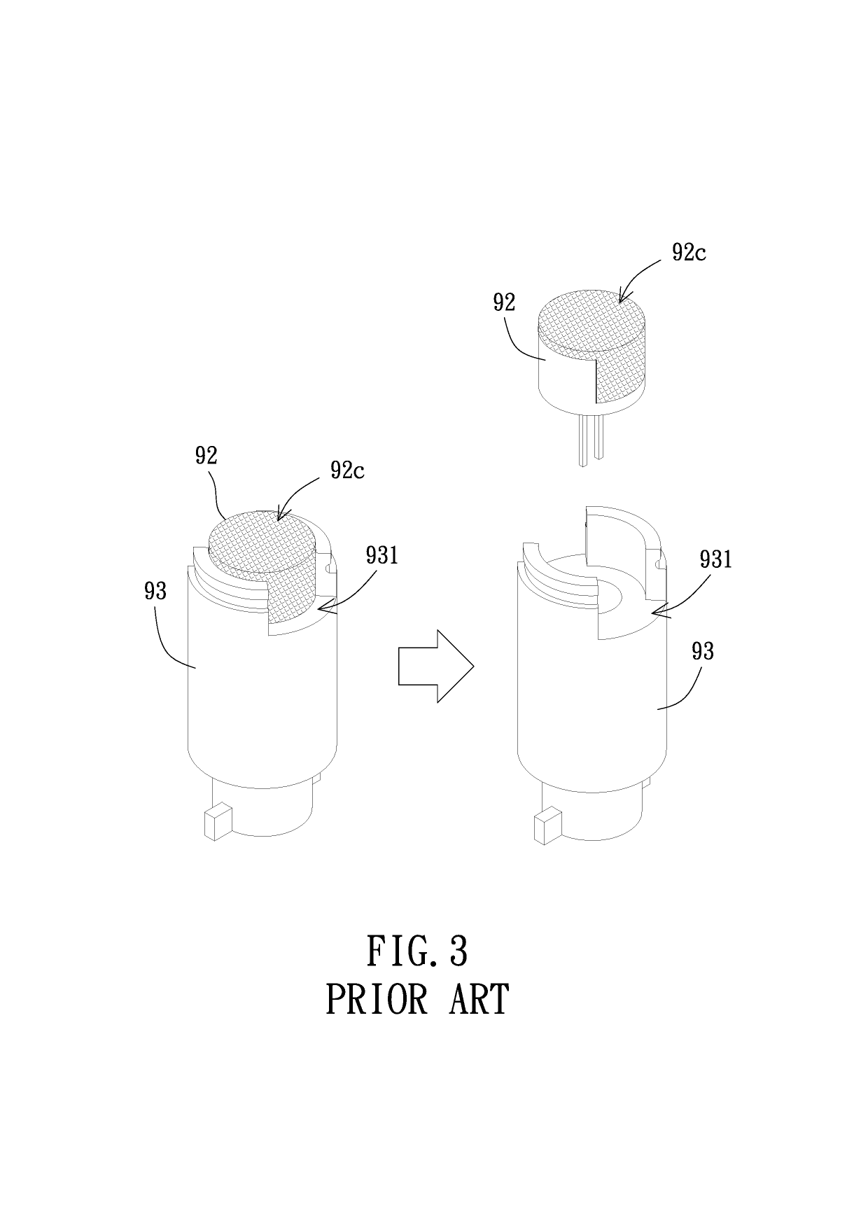

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

In order to make the above and other objectives, features, and advantages of the present invention clearer and easier to understand, preferred embodiments of the present invention will be described hereinafter in connection with the accompanying drawings. Furthermore, the elements designated by the same reference numeral in various figures will be deemed as identical, and the description thereof will be omitted.

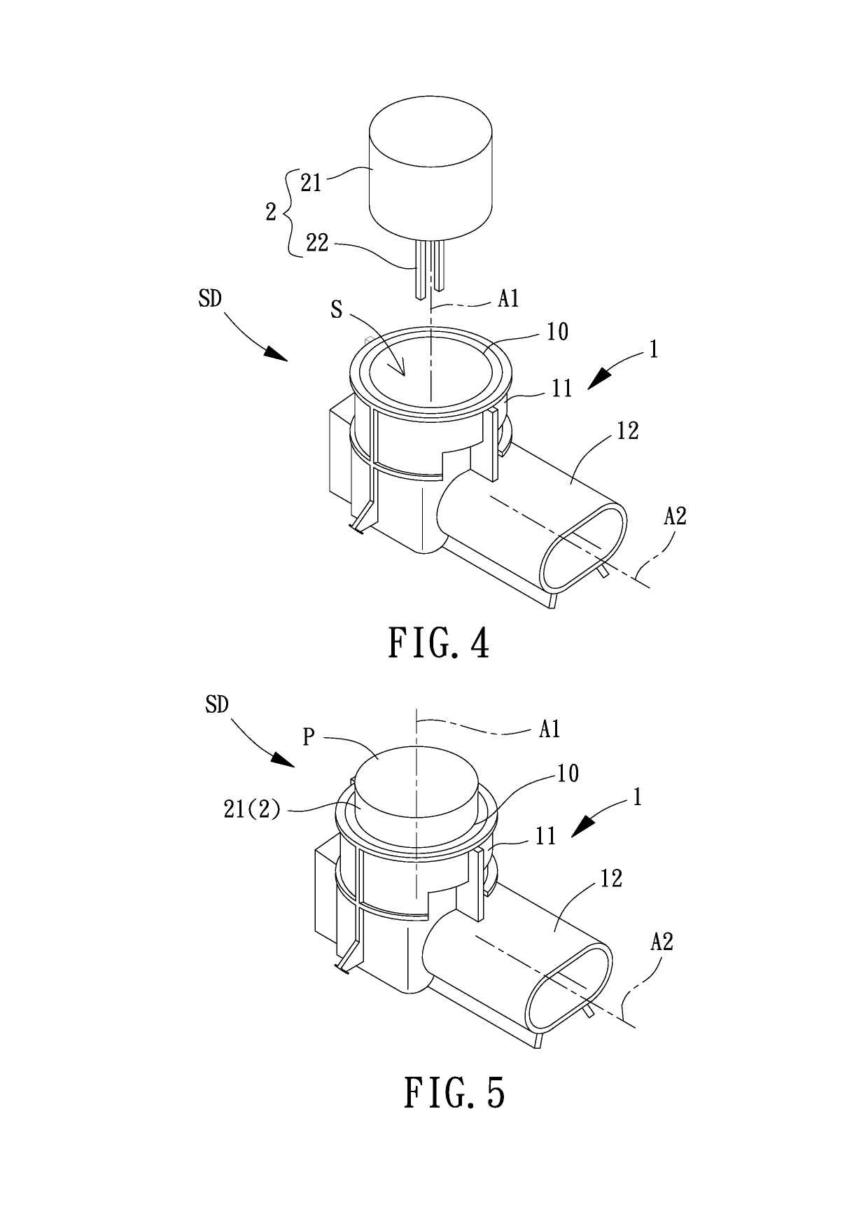

With reference to FIGS. 4 and 5, a first embodiment of a sensor SD according to the present invention includes a carrier 1 and a sensing unit 2. The sensing unit 2 is installed on the carrier 1.

The carrier 1 defines a receiving space S therein. Particularly, the carrier 1 includes an opening 10 intercommunicating with the receiving space S. Specifically, the carrier 1 includes a first extension 11 and a second extension 12. The opening 10 is provided on the first extension 11. The receiving space S is at least disposed in the first extension 11. The second extension 12 is connected to the first extension 11. Optionally, the receiving space S may extend into the second extension 12. Particularly, the first extension 11 extends along a first axis A1, and the second extension 12 extends along a second axis A2. Optionally, the first axis A1 is non-parallel to the second axis A2, such that a specific angle is provided between the first axis A1 and the second axis A2. Optionally, the first axis A1 is parallel to and misaligned from the second axis A2, such that the first extension 11 is misaligned from the second extension 12. According to the form shown in FIGS. 4 and 5 of the present invention, the first axis A1 is substantially at an angle of 90 degrees to the second axis A2. Nevertheless, the present invention is not limited in this regard.

The sensing unit 2 is partially received in the receiving space S, particularly disposed in the first extension 11. A portion of the sensing unit 2 protruding beyond the carrier 1 forms a protruding portion P. By the above disposition, it can be appreciated that the sensor SD according to the present invention includes a carrier 1 and a protruding portion P which is disposed on the carrier 1 and protrudes beyond the carrier 1. Specifically, the sensing unit 2 includes a body 21 and an electrical connecting portion 22. Particularly, the electrical connecting portion 22 protrudes outward from the body 21. A portion of the body 21 protruding beyond the carrier 1 forms the protruding portion P. The body 21 includes a signal transmitting unit and a signal receiving unit respectively for transmitting and receiving signals (preferably radar signals). The carrier 1 further includes a circuit board (not shown). The electrical connecting portion 22 is electrically connected to the circuit board to control signal transmission and receiving of the body 21 via the circuit board. Namely, when the sensing unit 2 is installed on the carrier 1, the electrical connecting portion 22 extends from the body 21 into the receiving space S for electrical connection with the circuit board in the receiving space S.

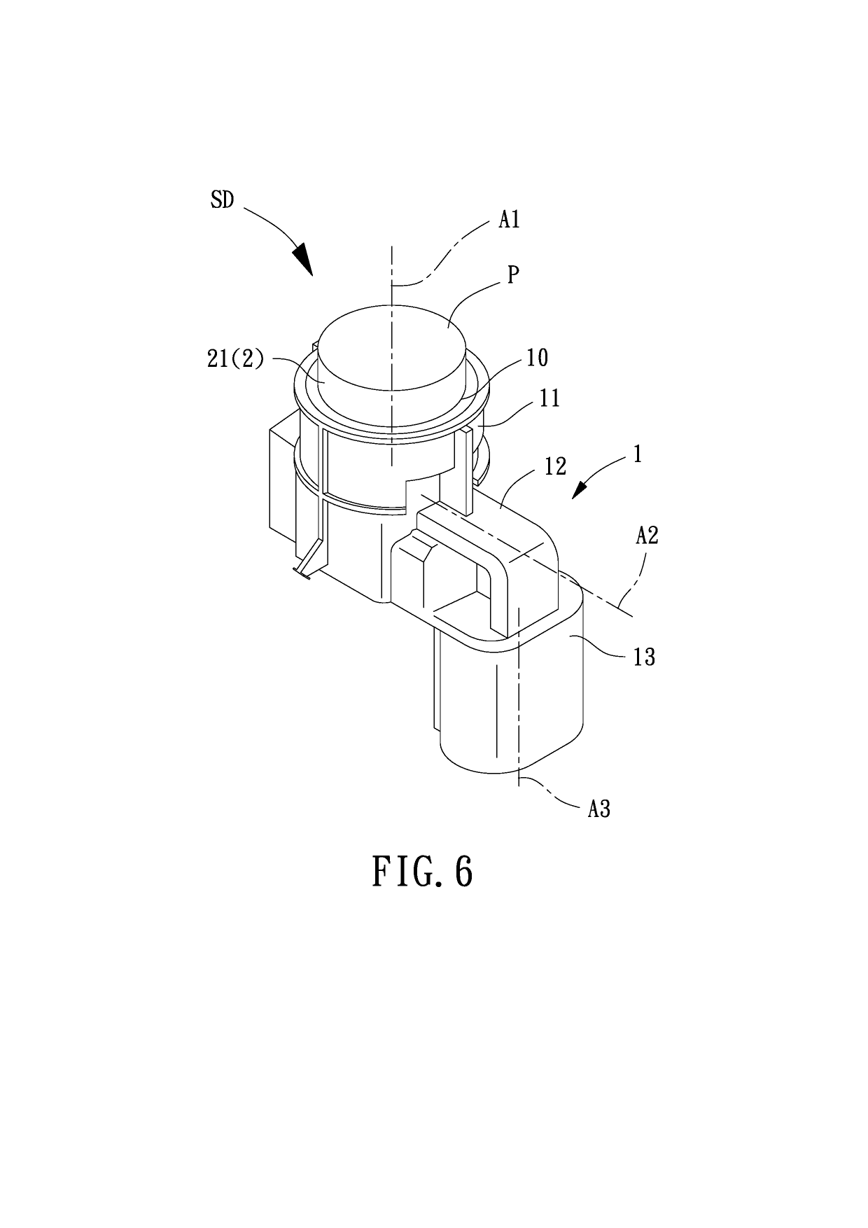

Please refer to FIG. 6 illustrating a sensor SD of a second embodiment according to the present invention. This embodiment is substantially the same as the first embodiment above. The main differences are that the carrier 1 in this embodiment further includes a third extension 13 connected to the second extension 12. Particularly, the third extension 13 extends along a third axis A3. Optionally, the third axis A3 is non-parallel to the second axis A2, such that a specific angle is provided between the third extension 13 and the second extension 12. Optionally, the third axis A3 is parallel to and misaligned from the second axis A2, such that the third extension 13 is misaligned from the second extension 12. According to the form shown in FIG. 6 of to the present invention, the third axis A3 is substantially at an angle of 90 degrees to the second axis A2. Furthermore, the third extension 13 and the first extension 11 extend from the second extension 12 in opposite directions. Nevertheless, the present invention is not limited in this regard.

It should be noted that in practical application, a circuit board (not shown) is disposed in the carrier 1 of the sensor SD and may be used to couple (by contacting) with the sensing unit 2. Particularly, the sensing unit 2 is electrically connected to the circuit board by the electrical connecting portion 22, such that the circuit board may receive, convert, or control the signals transmitted or received by the sensing unit 2. Furthermore, the circuit board may be connected to an external power supply to provide the power required by the sensing unit 2. In the embodiment of the invention shown in FIG. 5, the first extension 11 and the second extension 12 of the body 21 are disposed to have an angle of 90 degrees therebetween, whereas in the embodiment of the invention shown in FIG. 6, the third extension 13 and the second extension 12 of the body 21 are disposed to have an angle of 90 degrees therebetween, which may be selected according to the disposition of the installation location and the power supply layout of the sensor SD. Furthermore, the angle between the second axis A2 and the first axis A1 and/or the angle between the second axis A2 and the third axis A3 is not limited to 90 degrees.

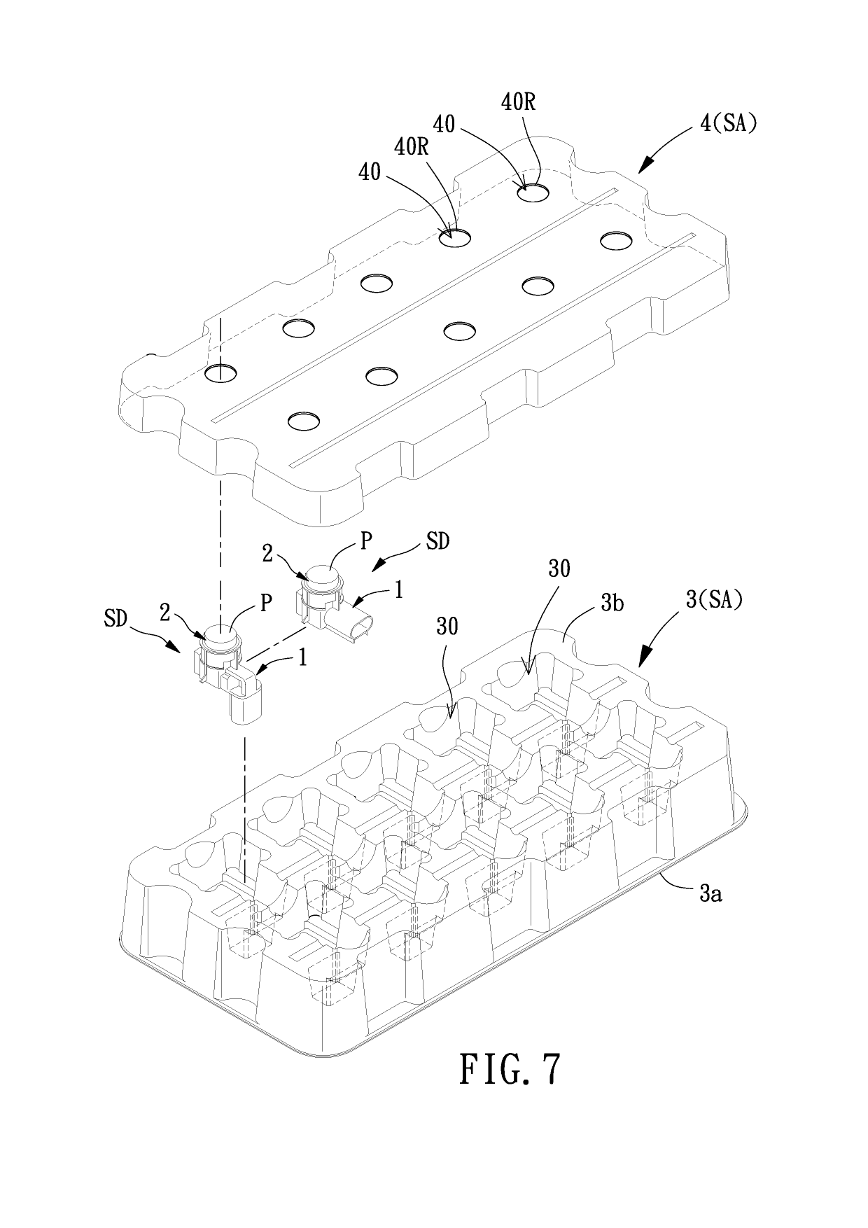

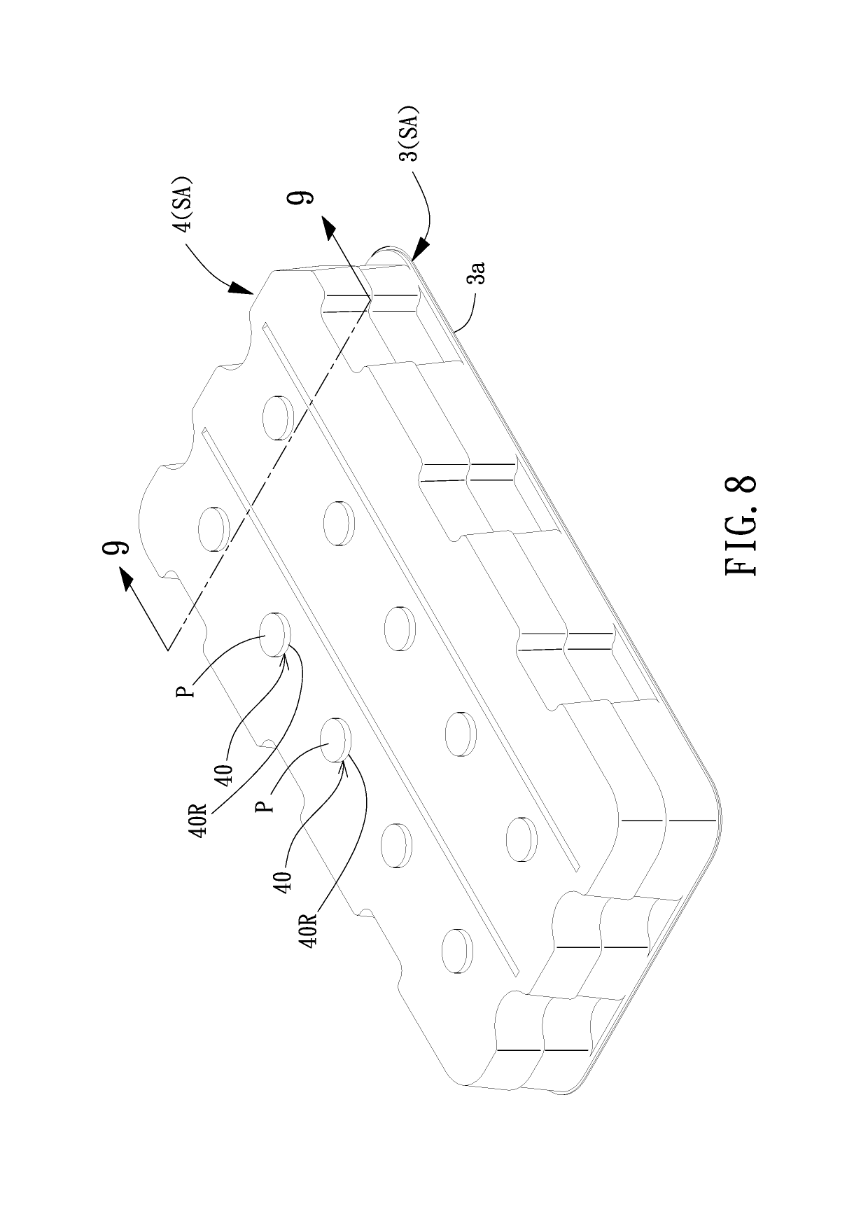

Please refer to FIGS. 7-9 illustrating a first embodiment of a shielding assembly SA according to the present invention. The shielding assembly SA is disposed corresponding to the sensor SD, such that the shielding assembly SA may shield the sensor SD in a case that the sensing unit 2 is pre-installed on the carrier 1. Furthermore, a portion of the protruding portion P outside of the shielding assembly SA fulfills the requirement of a pre-defined painting area, and the painting area forms a corresponding painting layer PC.

Specifically, the shielding assembly SA includes a base 3 and a shielding cover 4. The base 3 includes a plurality of grooves 30 for receiving sensors SD. Particularly, the shape of each groove 30 corresponds to the shape of the carrier 1 of the respective sensor SD. Specifically, when viewed from top, a peripheral contour surrounded by a sidewall WS of each groove 30 may surround the outline of the respective carrier 1.

Particularly, a bottom portion WB of each groove 30 includes at least two stepped planes to receive either of the sensors SD of two different embodiments shown in FIGS. 5 and 6. Specifically, the base 3 includes a bottom end 3a and a top end 3b opposite to the bottom end 3a. In the example of the bottom portion WB having at least two stepped planes, each groove 30 extends from the top end 3b toward the bottom end 3a to include a first bottom face 30a and a second bottom face 30b. The first bottom face 30a and the second bottom face 30b respectively form two planes at different heights to thereby form two-stepped planes of the bottom portion WB. The first bottom face 30a is used to support the second extension 12 of the sensor SD of FIG. 5 or the sensor SD of FIG. 6. The space between the second bottom face 30b and the first bottom face 30a may be used to receive the third extension 13 of the senor SD of FIG. 5. Namely, by provision of the base portion WB (having at least two stepped planes) of the groove 30 of the base 3, the base 3 is versatile and may be receive sensors SD of different shapes to increase the convenience in use. Nevertheless, the bottom portion WB of each groove 30 of the base 3 may include only one plane to specifically receive the sensor SD shown in FIG. 5. Furthermore, it is noted that the shapes of the sensors SD and the grooves 30 should not be limited to those shown in the drawings according to the present invention.

The shielding cover 4 includes a plurality of through-holes 40. When each sensor SD is placed into a respective groove 30 of the base 3, the shielding cover 4 can be disposed in the base 3, such that each through-hole 40 surrounds the protruding portion P of the sensor SD. Furthermore, the portion of the protruding portion P outside of the shielding cover 4 fulfills the requirement of a pre-defined painting area, such that the painting area forms a corresponding painting layer PC in a corresponding painting process, and a gap portion GP is formed between the painting layer PC and the carrier 1. Namely, the gap portion GP is an unpainted area of the protruding portion P. Preferably, the painting layer PC and the gap portion GP have different colors. Optionally, the painting process may be spraying or printing to adhere a corresponding colorant to the painting area, thereby forming the painting layer PC. Particularly, the shielding cover 4 may be made of polymers, preferably, polypropylene.

Specifically, in the first embodiment of the shielding assembly SA, the shielding cover 4 is disposed on the base 3 to shield the carrier 1 of each sensor SD. Furthermore, a periphery 40R of each through-hole 40 of the shielding cover 4 surrounds and comes in contact with the protruding portion P of a respective sensor SD at a specific height to avoid the colorant from being painted to a portion (namely, the gap portion GP) outside of the painting area of the protruding portion P. Namely, the shielding cover 4 preferably shields the whole carrier 1, and the shielding cover 4 shields a local area of the protruding portion P, such that the shielded area of the protruding portion P forms the gap portion GP, whereas the exposed/unshielded area of the protruding portion P forms the painting area.

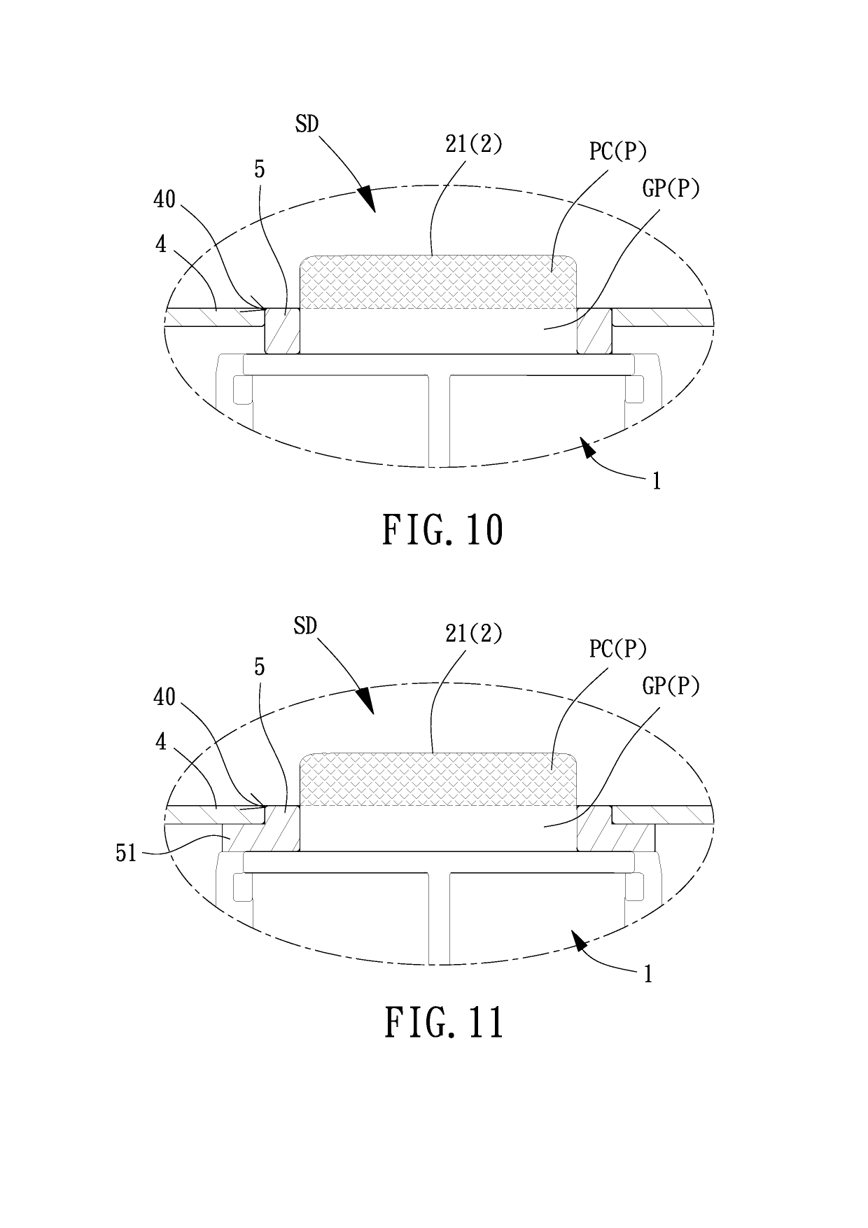

Please refer to FIG. 10 illustrating a second embodiment of the shielding assembly SA according to the present invention. This embodiment is substantially the same as the first embodiment above of the shielding assembly SA and further includes a plurality of annular shielding members 5. Each annular shielding member 5 corresponds to a respective through-hole 40. When the shielding cover 4 is disposed on the base 3 to shield the carrier of each sensor SD, each annular shielding member 5 is received in a respective through-hole 40. Furthermore, each annular shielding member 5 surrounds the gap portion GP of the protruding portion P to avoid the colorant from being painted on the gap portion GP.

Please refer to FIG. 11 illustrating a third embodiment of the shielding assembly SA according to the present invention. This embodiment is substantially the same as the second embodiment above of the shielding assembly SA. Furthermore, each annular shielding member 5 further includes a flange 51 protruding outward. Preferably, when the shielding cover 4 is disposed on the base to shield the carrier 1 of each sensor SD, each flange 51 extends downward from the shielding cover 4 in a radial direction and extends beyond the periphery 40R of the respective through-hole 40. Thus, when an error exists in the size and/or location of each through-hole 40 and each annular shielding member 5 and, thus, leads to a gap between the periphery 40R of each through-hole 40 and the respective annular shielding member 5, each flange 51 may avoid the colorant from infiltrating through the gap and adhering to the carrier 1 of the respective sensor SD.

Specifically, in the second and third embodiments of the shielding assembly SA according to the present invention, since the periphery 40R of each through-hole 40 of the shielding cover 4 surrounds and contacts with a respective annular shielding member 5 and since each annular shielding member 5 surrounds the gap portion GP of the protruding portion P, the colorant is avoided from being painted on the gap portion GP. Particularly, the annular shielding members 5 may be made of polymers, preferably, silicone or silicone resin.

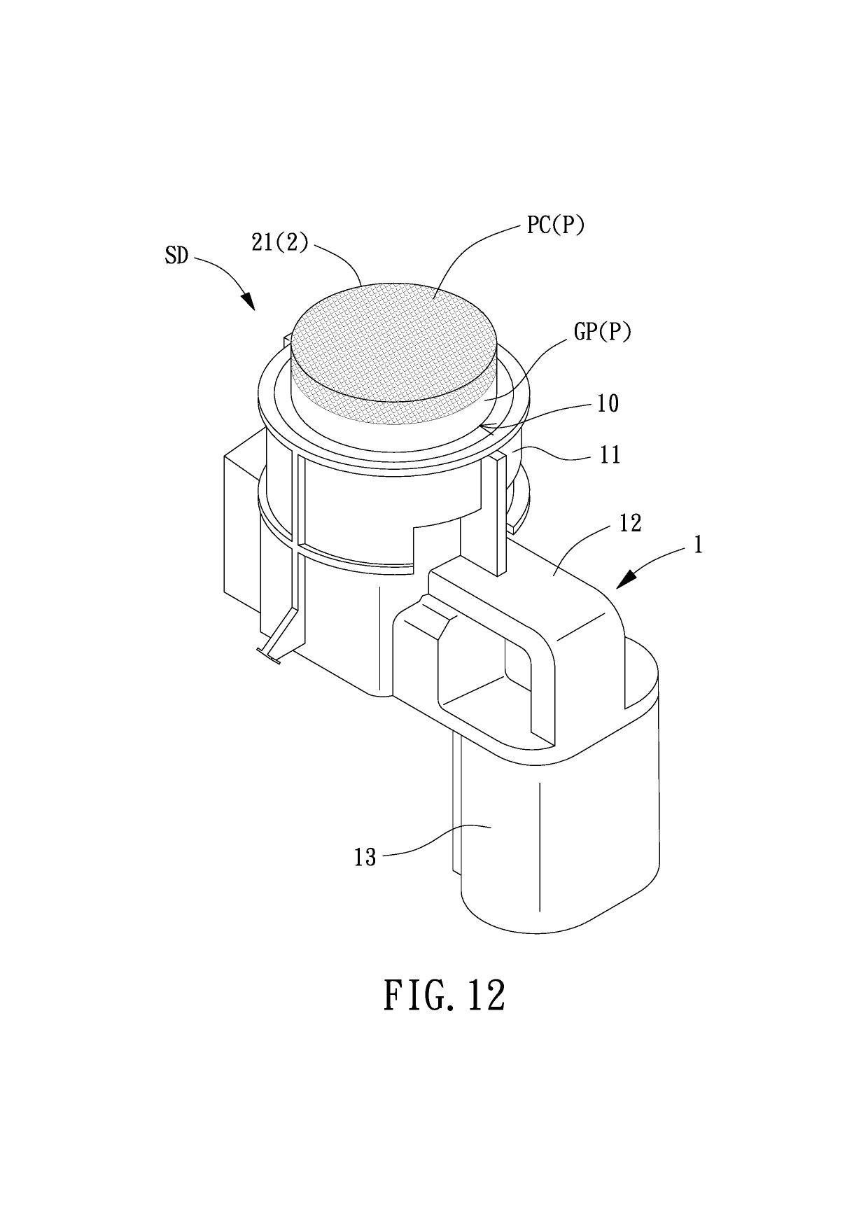

Please refer to FIG. 12 illustrating a sensor SD which is painted using the shielding assembly SA according to the present invention. The painting area of the protruding portion P of the sensor SD includes the painting layer PC. The gap portion GP is provided between the painting layer PC and the carrier 1. Furthermore, the painting layer PC and the gap portion GP have different colors. It should be noted that although the carrier 1 of FIG. 12 is the type shown in FIG. 6, the painted sensor SD according to the present invention may, but is not limited to, include a carrier 1 of the type shown in FIG. 5.

According to the sensor SD and the shielding assembly SA according to the present invention, the present invention may carry out a sensor painting method including the following steps.

In step S1, a sensor SD (as shown in FIG. 5 or 6), is provided. The sensor SD includes a carrier 1 and a protruding portion P. The protruding portion P protrudes beyond the carrier 1.

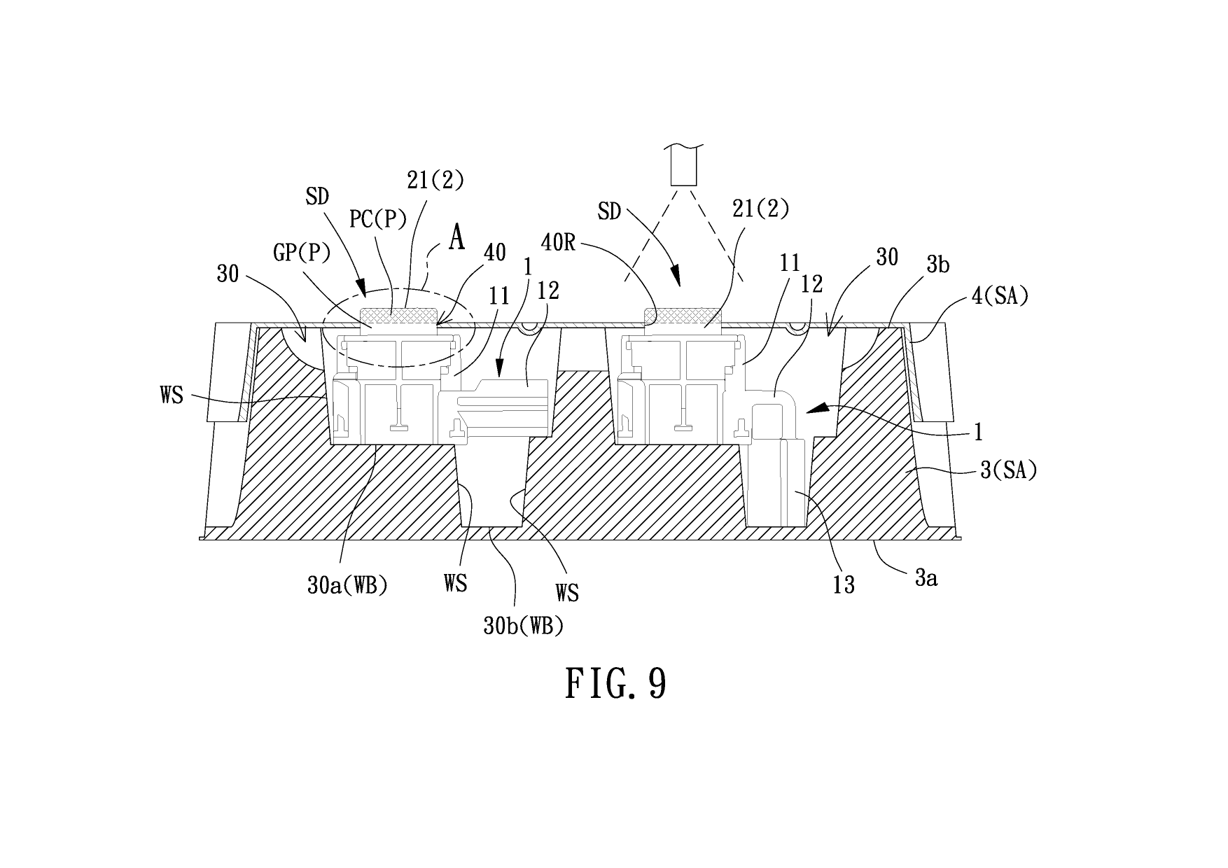

In step S2, a shielding assembly SA is provided to shield the sensor SD/the protruding portion P, as shown in any one of FIGS. 9-11, such that a painting area of the protruding portion P is exposed. Specifically, the shielding assembly SA/the shielding cover 4 shields a local area of the protruding portion P, such that the exposed/unshielded area of the protruding portion P forms the painting area, and the shielded area of the protruding portion P forms the gap portion GP.

In step S3, a painting layer PC is formed on the painting area, as shown in FIG. 12. Particularly, the painting layer PC and the carrier 1 have the gap portion GP therebetween. Furthermore, the painting layer PC and the gap portion GP have different colors. The painting layer PC may be formed by spraying or printing. Furthermore, after the painting layer PC is formed, the shielding assembly SA can be removed to obtain the painted sensors SD.

In summary, in the sensor painting method, the shielding assembly and the sensor according to the present invention, by shielding the protruding portion with the shielding assembly to expose the painting area of the protruding portion and by forming the painting layer and the gap portion on the protruding portion, painting may be carried out on the whole sensor assembled with the carrier and the sensing unit, thereby saving the time for installing the sensing unit on the carrier after painting. Furthermore, the sensor is preassembled before painting, which saves the inventory space for the carrier and the sensing unit, thereby simplifying the inventory management. Furthermore, by providing the shielding cover of the shielding assembly with a plurality of through-holes, the protruding portion of each sensor may extend through a respective through-hole, such that plural sensors (each assembled with a carrier and a sensing unit) may be simultaneously painted in a painting process, thereby increasing the painting efficiency. Furthermore, by the provision of the shielding assembly including a plurality of annular shielding members each of which is associated with a respective one of the plurality of through-holes, the colorant is avoided from being painted on a portion outside of the painting area of the protruding portion. Furthermore, by provision of the plurality of grooves in the base of the shielding assembly, the bottom portion of each groove includes at least two stepped planes (such as the first bottom face and the second bottom face), sensors of at least two different shapes may be received.

Although the present invention has been described with respect to the above preferred embodiments, these embodiments are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims. Furthermore, in a case that several of the above embodiments can be combined, the present invention includes the implementation of any combination.

What is claimed is:

1. A sensor painting method comprising:
providing a sensor including a carrier and a sensing unit, wherein the sensor is pre-assembled to install the sensing unit on the carrier, wherein a portion of the sensing unit protruding beyond the carrier forms a protruding portion;
providing a shielding assembly to shield the protruding portion, such that an area of the protruding portion shielded by the shielding assembly forms a gap portion, and another area of the protruding portion outside of the shielding assembly forms a painting area; and
forming a painting layer on the painting area, wherein the painting layer and the gap portion have different colors.

2. The sensor painting method as claimed in claim 1, wherein the painting layer is formed by spraying or printing.

3. A shielding assembly used in the painting method as claimed in claim 1, wherein the shielding assembly includes a shielding cover having a plurality of through-holes.

4. The shielding assembly as claimed in claim 3, further comprising a plurality of annular shielding members, wherein each of the plurality of annular shielding members is disposed in a respective one of the plurality of through-holes.

5. The shielding assembly as claimed in claim 4, wherein each of the plurality of annular shielding members includes a flange protruding outward, wherein when each of the plurality of annular shielding members is disposed in the respective one of the through-holes, each flange extends downward from the shielding cover in a radial direction and extends beyond a periphery of the respective through-hole.

6. The shielding assembly as claimed in claim 3, wherein the shielding cover is made of polypropylene.

7. The shielding assembly as claimed in claim 4, wherein the plurality of annular shielding members is made of silicone or silicone resin.

8. The shielding assembly as claimed in claim 3, further comprising a base having a plurality of grooves, wherein each of the plurality of grooves includes a bottom portion having at least two stepped planes.

9. The shielding assembly as claimed in claim 4, further comprising a base having a plurality of grooves, wherein each of the plurality of grooves includes a bottom portion having at least two stepped planes.

10. A sensor comprising:
a carrier including a receiving space;
a sensing unit including a body partially received in the receiving space, such that a portion of the body protruding beyond the carrier forms a protruding portion; and
a painting layer disposed on the protruding portion, wherein a gap portion is formed between the painting layer and the body, and wherein the painting layer and the gap portion have different colors.

11. The sensor as claimed in claim 10, further comprising a circuit board disposed in the receiving space, wherein the sensing unit further includes an electrical connecting portion extending outward from the body and electrically connected to the circuit board.
